(19) United States
(12) Patent Application Publication
(10) Pub. No.: US 2013/0301210 A1
(43) Pub. Date: Nov. 14, 2013

(54) ELECTRONIC DEVICE ENCLOSURE WITH BRACKET FOR DATA STORAGE DEVICES

(71) Applicant: HON HAI PRECISION INDUSTRY CO., LTD., New Taipei (TW)

(72) Inventors: SHENG-HUNG LEE, New Taipei (TW); LI-PING CHEN, New Taipei (TW)

(73) Assignee: HON HAI PRECISION INDUSTRY CO., LTD., New Taipei (TW)

(21) Appl. No.: 13/758,009

(22) Filed: Feb. 4, 2013

(30) Foreign Application Priority Data
May 14, 2012 (TW) 101117037

(51) Int. Cl. G06F 1/18

(52) U.S. Cl. CPC G06F 1/187
USPC 361/679.33

(57) ABSTRACT

An electronic device enclosure includes a bracket, a first housing, a second housing, and a third housing, to provide mass storage capacity in the form of different mass storage devices. The bracket includes a first clipping plate and a second clipping plate substantially parallel to the first clipping plate. The first housing is configured to receive a first data storage device and is engaged between the first clipping plate and the second clipping plate. The second housing is configured to receive a second data storage device and is engaged between the first clipping plate and the second clipping plate. The third housing is configured to receive a third data storage device and is engaged between the first clipping plate and the second clipping plate.

### BACKGROUND

1. Technical Field

The present disclosure relates to electronic device enclosures, more particularly to an electronic device enclosure with a bracket for receiving different data storage devices.

2. Description of Related Art

In a computer or server, data storage devices, such as CD-ROM drives, hard disk drives, floppy disk drives, and optical drives may be needed to store mass data. A bracket may be designed to receive a data storage device, and the bracket together with the data storage device are secured to an enclosure of the computer. A conventional bracket may only receive one data storage device. However, a single data storage device will not satisfy present mass data requirements. Thus, a bracket capable of receiving multiple data storage devices is needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an electronic device enclosure in accordance with an embodiment.

FIG. 2 is an isometric view of a bracket of FIG. 1.

FIG. 3 is an enlarged view of the circled portion III of FIG. 2.

FIG. 4 is an isometric view of a first housing, a second housing and a third housing of FIG. 1.

FIG. 5 is an assembled view of the electronic device enclosure of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

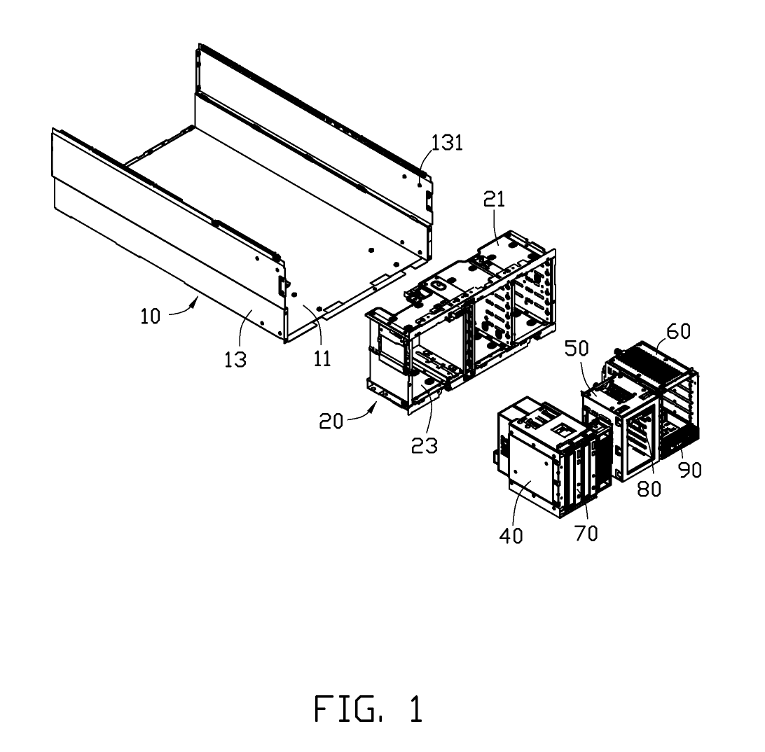

FIG. 1 illustrates an electronic device enclosure in accordance with an embodiment. The electronic device enclosure includes a base 10, a bracket 20, a first housing 40, a second housing 50, and a third housing 60. The first housing 40 can receive a plurality of first data storage devices 70, for example, CD-ROM drives. The second housing 50 can receive a plurality of second data storage devices 80, for example, hard disk drives. The third housing 60 can receive a plurality of third data storage devices 90, for example, hard disk drives. The size of the first data storage devices 70 is different from the size of the second data storage devices 80 and is different from the size of the third data storage devices 90.

The base 10 includes a bottom plate 11 and two side plates 13 parallel to each other. The two side plates 13 are located on two opposite sides of the bottom plate 11. A plurality of securing members 131 are located on each of the two side plates 13, for securing the bracket 20.

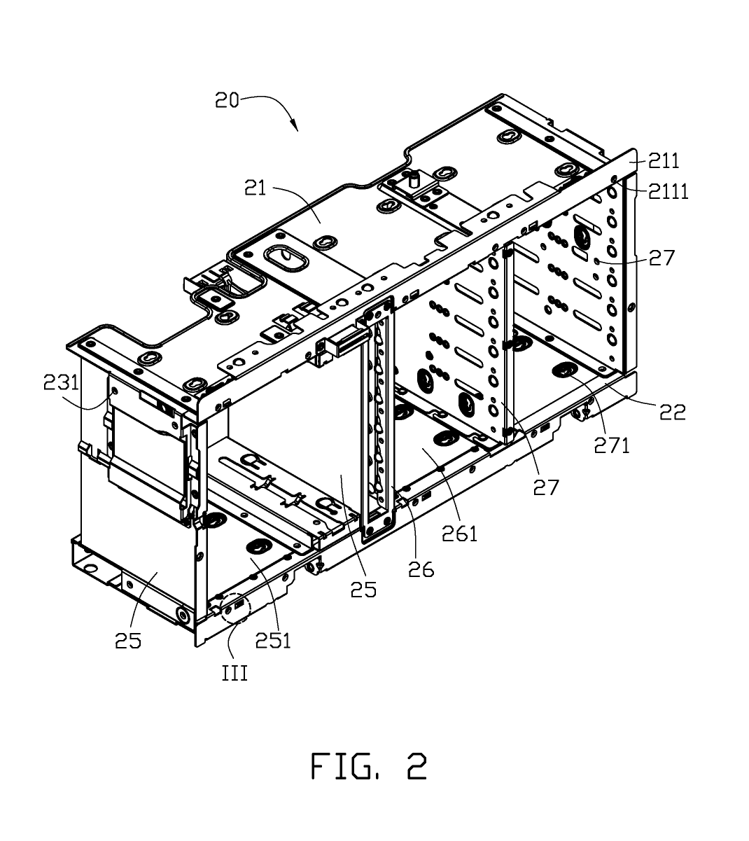

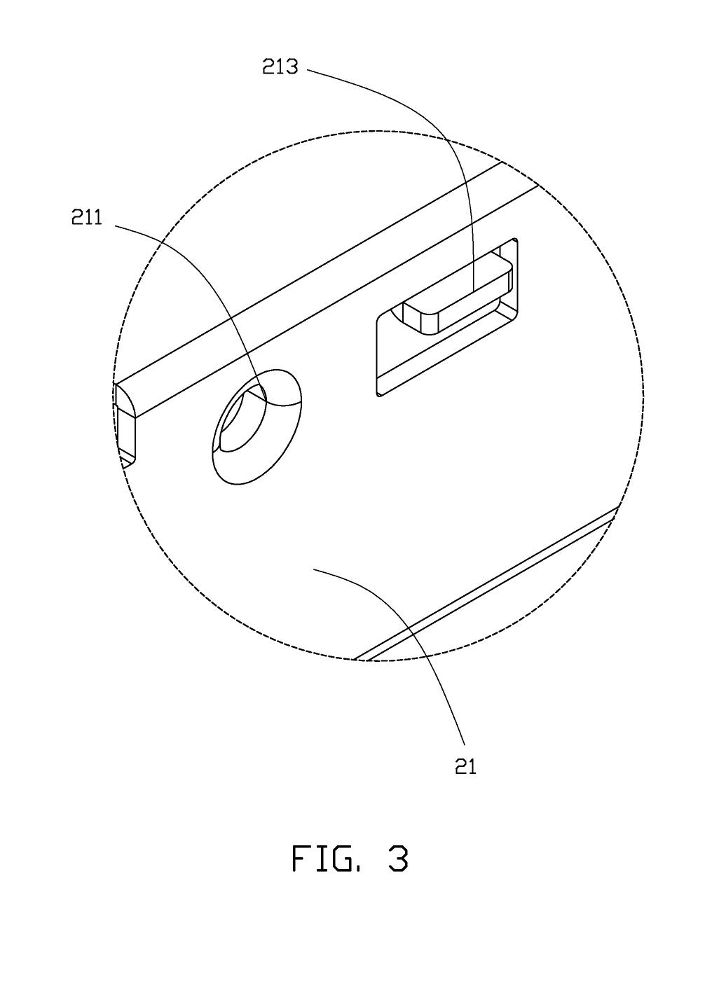

Referring to FIGS. 2-3, the bracket 20 includes a first clipping plate 21, a second clipping plate 22, a first securing board 23, and a second securing board 24. The first clipping plate 21 is substantially parallel to the second clipping plate 22. The first securing board 23 and the second securing board 24 are substantially parallel to each other and are connected to the first clipping plate 21 and the second clipping plate 22 respectively. The first securing board 23 and the second securing board 24 define a plurality of locking holes 231 corresponding to the plurality of securing members 131 of the two side plates 13 of the base 10. A flange 211 extends outwards from one edge of each of the first clipping plate 21 and the second clipping plate 22. The flange 211 defines a plurality of through holes 2111, and three positioning blocks 213 protrude from each of the flange 211, for positioning the first housing 40, the second housing 50, and the third housing 60.

The bracket 20 further includes a first dividing plate 25, a second dividing plate 26, and a third dividing plate 27. The first dividing plate 25, the second dividing plate 26, and the third dividing plate 27 are located between the first clipping plate 21 and the second clipping plate 22 and are perpendicular with the first clipping plate 21 and the second clipping plate 22. The first dividing plate 25, the first securing board 23, the first clipping plate 21, and the second clipping plate 22 cooperatively define a first receiving space 251 for receiving the first housing 40. The second dividing plate 26, the third dividing plate 27, the first clipping plate 21, and the second clipping plate 22 cooperatively define a second receiving space 261 for receiving the second housing 50. The third dividing plate 27 and the second securing board 24 cooperatively define a third receiving space 271 for receiving the third housing 60.

The first housing 40 includes a first top wall 41, a first bottom wall 43 and two first sidewalls 45. The first top wall 41 is substantially parallel to the first bottom wall 43, and a first distance is defined between the first top wall 41 and the first bottom wall 43. A first latch piece 411 extends outwards from each of the first top wall 41 and the first bottom wall 43. Two first latch holes 4111 are defined in two opposite ends of each first latch piece 411. A first positioning hole 4113, corresponding to the positioning block 213, is defined in each first latch piece 411 adjacent to one of the two first latch holes 4111. A limiting portion 413 extends inwards from each of the first top wall 41 and the first bottom wall 43. A restricting portion 451 extends inward from one of the two first sidewalls 45. The limiting portion 413 and the restricting portion 451 cooperatively limit the size of the first housing 40 to receive the first data storage devices 70.

The second housing 50 includes a second top wall 51, a second bottom wall 53 and two second sidewalls 55. The second top wall 51 is substantially parallel to the second bottom wall 53, and a second distance is defined between the second top wall 51 and the second bottom wall 53. Two second latch pieces 511 extend outwards from outer surfaces of each of the second top wall 51 and the second bottom wall 53. A second latch holes 5111 is defined in each of the two latch pieces 511, corresponding to the through holes 2111 of the bracket 20. A second positioning hole 5113, corresponding to one of the positioning blocks 213, is defined in each of the two latch pieces 511 adjacent to the second latch holes 5111. A limiting piece 513 is located on an inner side of the second top wall 51, to limit size of the second housing 50 to receive the second data storage devices 80 . A positioning plate 551 is arranged between the second top wall 51 and the second bottom wall 53, on one side of one of the two second sidewalls 55.

The third housing 60 includes a third top wall 61, a third bottom wall 63, and two third sidewalls 65. The third top wall 61 is substantially parallel to the third bottom wall 63, and a third distance is defined between the third top wall 61 and the third bottom wall 63. The first distance is substantially equal to the second distance and to the third distance. A third latch piece 611 extends from an outer surface of each of the third top wall 61 and the third bottom wall 63. Two third latch holes 6111 are defined in each third latch piece 611. A third positioning hole 6113, corresponding to one of the positioning blocks 213, is defined in each third latch piece 611 adjacent to one of the third latch holes 6111.

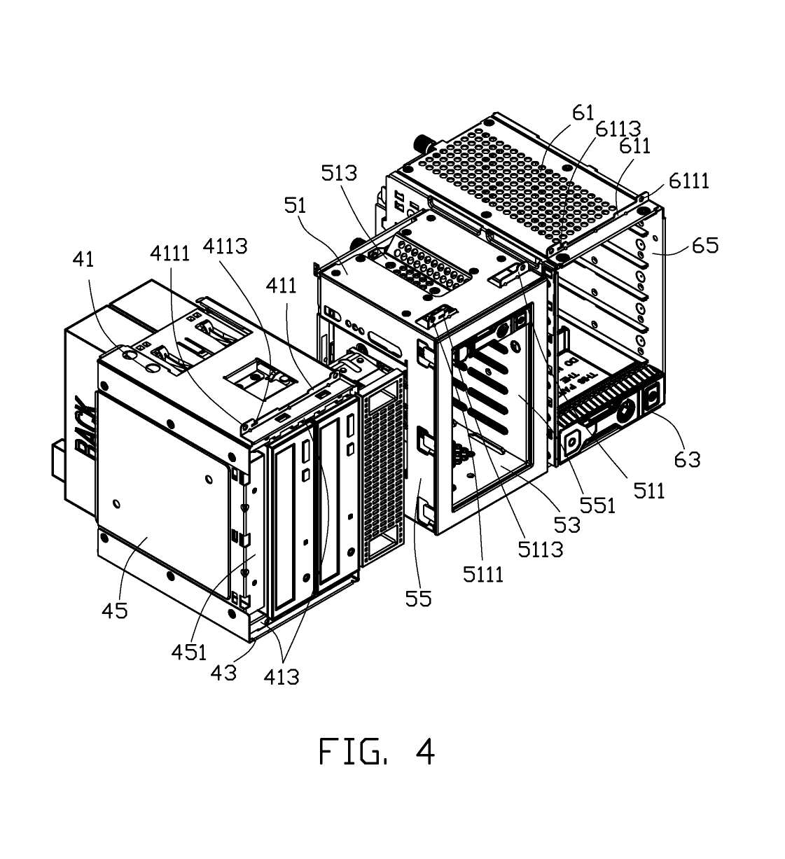

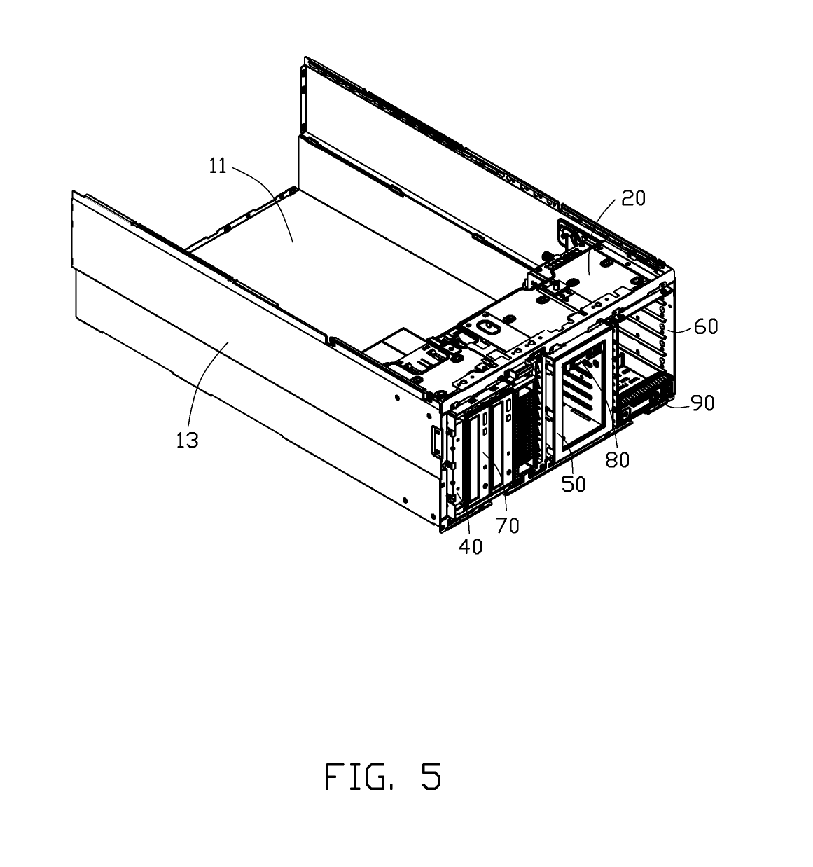

Referring to FIGS. 4-5, in assembly, the bracket 20 is located between the two side plates 13. Each of plurality of securing members 131 is aligned with each of plurality of the locking holes 231, and a plurality of screws (not shown) are locked into the plurality of the securing members 131 and the plurality of the locking holes 231, to secure the bracket 20 to the base 10.

In assembly of the first housing 40, the first housing 40 is pushed into the first receiving space 251. The first latch piece 411 abuts the flange 211 of the bracket 20. One of the positioning blocks 213 is inserted into the first positioning hole 4111, and the two first latch holes 4111 are aligned with two of the plurality of through holes 2111. Two locking members are locked into the two first latch holes 4111 and the two through holes 2111, to secure the first data storage devices 70 to the bracket 20.

In assembly of the second housing 50, the second housing 50 is pushed into the second receiving space 261. The two second latch piece 511 abuts the flange 211 of the bracket 20. One of the positioning blocks 213 is inserted into the second positioning hole 5113, and the two second latch holes 5111 are aligned with two of the plurality of through holes 2111. Two locking members (not shown) are locked into the two second latch holes 5111 and the two through holes 2111, to secure the second data storage devices 80 to the bracket 20.

In assembly of the third housing 60, the third housing 60 is pushed into the third receiving space 271. The third latch piece 611 abuts the flange 211 of the bracket 20. The other one of the positioning blocks 213 is inserted into the third positioning hole 5113, and the two third latch holes 6111 are aligned with two of the plurality of through holes 2111. Two locking members (not shown) are locked into the two third latch holes 6111 and the two through holes 2111, to secure the third data storage devices 90 to the bracket 20.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device enclosure comprising:
a bracket comprising a first clipping plate and a second clipping plate substantially parallel to the first clipping plate;
a first housing configured to receive a first data storage device, the first housing engaged between the first clipping plate and the second clipping plate;
a second housing configured to receive a second data storage device, the second housing engaged between the first clipping plate and the second clipping plate; and
a third housing configured to receive a third data storage device, the third housing engaged between the first clipping plate and the second clipping plate.

2. The electronic device enclosure of claim 1, wherein the first housing comprises a first top wall and a first bottom wall, a first distance is defined between the first top wall and the first bottom wall; the second housing comprises a second top wall and a second bottom wall, a second distance is defined between the second top wall and the second bottom wall; the third housing comprises a third top wall and a third bottom wall, a third distance is defined between the third top wall and the third bottom wall; the first distance is equal to the second distance and the third distance, and the second distance is equal to the third distance.

3. The electronic device enclosure of claim 2, wherein each of two limiting portions extend inwards from each of the first top wall and the first bottom wall, and the two limiting portions are configured to define a size of the first housing to clip the first data storage device.

4. The electronic device enclosure of claim 2, wherein a limiting piece is located on the second top wall, and the limiting piece is substantially parallel to the second bottom wall.

5. The electronic device enclosure of claim 4, wherein a positioning plate is connected to the second top wall and the second bottom wall, and the positioning plate is substantially perpendicular with the second top wall and the second bottom wall.

6. The electronic device enclosure of claim 5, wherein the limiting piece, the positioning plate and the second bottom plate cooperatively define limit the second housing to receive the second data storage device.

7. The electronic device enclosure of claim 2, wherein a flange extends from each of the first clipping plate and the second clipping plate, a first latch piece extends from each of the first top wall and the first bottom wall, and the first latch piece abuts the flange.

8. The electronic device enclosure of claim 7, wherein a second latch piece extends from each of the second top wall and the second bottom wall, and the second latch piece abuts the flange.

9. The electronic device enclosure of claim 8, wherein a third latch piece extend from each of the third top wall and the third bottom wall, and the third latch piece abuts the flange.

10. An electronic device enclosure comprising:
a base comprising two side plates substantially parallel to each other;
a bracket secured between the two side plates, the bracket defining a first receiving space, a second receiving space, and a third receiving space;
a first housing configured to receive a first data storage device, the first housing being received in the first receiving space;
a second housing configured to receive a second data storage device, the second housing being received in the second receiving space; and
a third housing configured to receive a third data storage device, the second housing being received in the third receiving space.

11. The electronic device enclosure of claim 10, wherein the bracket comprises a first clipping plate and a second clipping plate substantially parallel to the first clipping plate, the first housing is engaged between the first clipping plate and the second clipping plate; the second housing is engaged between the first clipping plate and the second clipping plate; and the third housing is engaged between first clipping plate and the second clipping plate.

12. The electronic device enclosure of claim 11, wherein the first housing comprises a first top wall and a first bottom wall, a first distance is defined between the first top wall and the first bottom wall; the second housing comprises a second top wall and a second bottom wall, a second distance is defined between the second top wall and the second bottom wall; the third housing comprises a third top wall and a third bottom wall, a third distance is defined between the third top wall and the third bottom wall; the first distance is equal to the second distance and the third distance, and the second distance is equal to the third distance.

13. The electronic device enclosure of claim 12, wherein each of two limiting portions extend inwards from each of the first top wall and the first bottom wall, and the two limiting portions are configured to define a size of the first housing to clip the first data storage device.

14. The electronic device enclosure of claim 12, wherein a limiting piece is located on the second top wall, and the limiting piece is substantially parallel to the second bottom wall.

15. The electronic device enclosure of claim 14, wherein a positioning plate is connected to the second top wall and the second bottom wall, and the positioning plate is substantially perpendicular with the second top wall and the second bottom wall.

16. The electronic device enclosure of claim 15, wherein the limiting piece, the positioning plate and the second bottom plate cooperatively define a size of the second housing to receive the second data storage device.

17. The electronic device enclosure of claim 12, wherein a flange extends from each of the first clipping plate and the second clipping plate, a first latch piece extends from each of the first top wall and the first bottom wall, and the first latch piece abuts the flange.

18. The electronic device enclosure of claim 17, wherein a second latch piece extends from each of the second top wall and the second bottom wall, and the second latch piece abuts the flange.

19. The electronic device enclosure of claim 18, wherein a third latch piece extend from each of the third top wall and the third bottom wall, and the third latch piece abuts the flange.
